(19) United States
(12) Patent Application Publication
(10) Pub. No.: US 2011/0253604 A1
(43) Pub. Date: Oct. 20, 2011

(54) OZONATION SYSTEM FOR TREATING SECONDARY WASTEWATER

(75) Inventors: Micheal D. Mercer, Bryan, TX (US); John R. Lund, College Station, TX (US); Mark J. Flusche, Muenster, TX (US)

(73) Assignee: LYNNTECH, INC., College Station, TX (US)

(21) Appl. No.: 13/085,595

(22) Filed: Apr. 13, 2011

Related U.S. Application Data
(60) Provisional application No. 61/324,139, filed on Apr. 14, 2010.

(51) Int. Cl. C02F 9/04; C02F 3/00; C02F 1/32; C02F 1/78

(52) U.S. Cl. 210/85; 210/150; 210/97; 210/151

(57) ABSTRACT

Septic systems incorporating an ozonation system comprise one or more corona discharge ozone generators receiving air, such as atmospheric air, and having an outlet for the withdrawal of a mixture of air and ozone gas. The system also comprises a septic tank for receiving primary wastewater, and a pump tank receiving secondary wastewater effluent from the septic tank. The ozonation system includes a submersible ozone introduction pump disposed in the bottom of the pump tank, wherein the ozone introduction pump includes an impeller within a housing, the housing having an inlet and a plurality of radial outlet ports along its circumferential area surrounding the impeller. A conduit couples the outlet of the corona discharge ozone generator to the inlet of the impeller housing, wherein the ozone introduction pump reduces pressure in the conduit to draw air into the ozone generator and draws the mixture of air and ozone gas into the impeller housing for introduction into the secondary wastewater. An optional ultraviolet light source may be disposed in the headspace of the pump tank to enhance the activity of the ozone.

### CROSS-REFERENCE TO RELATED APPLICATIONS

This application claims priority to co-pending U.S. provisional patent application Ser. No. 61/324,139, filed on Apr. 14, 2010.

### BACKGROUND

1. Field of the Invention

The present invention relates to the use of ozone in water treatment, specifically in wastewater treatment, and more specifically to secondary wastewater treatment in the effluent from septic systems that incorporate the use of ozone.

2. Background of the Related Art

A septic system is a small scale sewage treatment system common in areas with no connection to main sewage pipes provided by local governments or private corporations. The main component of a septic system is a septic tank, yet other components of a septic system may include pumps, alarms, sand filters, and clarified liquid effluent disposal means such as a septic drain field or a pond. A septic system is just one type of On-Site Sewage Facility (OSSF). The term “septic” refers to the anaerobic bacterial environment that develops in the tank and which decomposes or mineralizes the waste discharged into the tank. Septic tanks can be coupled with other on-site wastewater treatment units such as biofilters or aerobic systems involving forced aeration. (Source: Wikepedia.org).

A septic tank generally consists of a tank of between 300 and 5,000 gallons in size connected to an inlet wastewater pipe at one end and a septic drain field at the other. Current septic tank designs commonly incorporate two chambers (each of which is equipped with a manhole cover) which are separated by means of a dividing wall which has openings located about midway between the floor and roof of the tank. Primary wastewater enters the first chamber of the tank, allowing solids to settle and scum to float. The settled solids are anaerobically digested reducing the volume of solids. The liquid component flows through the dividing wall into the second chamber where further settlement takes place and the excess liquid then drains in a relatively clear condition from the outlet of the second chamber into the drain field, also known as a leach field or seepage field. The remaining impurities are trapped and eliminated in the soil, with the excess water eliminated through percolation into the soil, evaporation, or uptake through the root systems of plants.

U.S. Pat. No. 5,989,407 (Murphy) teaches that ozone (O₃) is recognized as a useful chemical commodity valued particularly for its outstanding oxidative activity. Because of this activity, it finds wide application in disinfection processes. In fact, it kills bacteria more rapidly than chlorine, decomposes organic molecules, and removes coloration in aqueous systems. Ozonation may also remove cyanides, phenols, iron, manganese, and detergents. It controls slime formation in aqueous systems, yet maintains high oxygen content in the system. Unlike chlorination, which may leave undesirable chlorinated organic residues in organic containing systems, ozonation leaves fewer potentially harmful residues. Ozone has also been shown to be useful in both gas and aqueous phase oxidation reactions which may be carried out by advanced oxidation processes (AOPs) in which the formation of OH radicals is enhanced by exposure to ultraviolet light. Consequently, ozone is used for sterilization in the brewing industry and for odor control in sewage treatment and manufacturing. On a commercial basis, ozone may be produced by the silent electric discharge process, otherwise known as corona discharge, wherein air or oxygen is passed through an intense, high frequency alternating current electric field. Yields for air fed corona discharge processes generally are in the vicinity of 2% by weight ozone in the exit gas. Murphy goes on to teach a method and apparatus for the electrochemical production of ozone in much higher concentrations, where the ozone is produced either as a gas stream or as a water stream containing dissolved ozone.

U.S. Publication 2008/0185335 (Holt) discloses a method and apparatus for remediating a wastewater treatment system, such as a private onsite wastewater treatment system comprising a septic tank, which is failing due to the accumulation of a thick biomat that is impeding absorption of further effluent. The apparatus includes a positive pressure pump delivering air, oxygen, ozone, or a combination thereof to an output coupled through a tube to an air stone. The air stone is suspended in the effluent to allow emission of bubbles on all sides of the air stone. A plurality of directional brushes is suspended over the air stone to capture bubbles and provide greater oxygen retention within the effluent tank and thus greater production of aerobic bacteria. The air, oxygen or ozone is introduced into the tank until the biomat in the leach field, comprising solids and bacteria, is sufficiently reduced or made permeable.

U.S. Pat. No. 4,250,040 (LaRaus) discloses a method for purifying septic tank effluent. Liquid effluent from a conventional septic tank is passed successively through a filter tank and a plurality of spaced ozonating tanks, at least one of which has an activated charcoal filter located intermediate its ends. The filtered liquid passes from the last ozonating tank into a reservoir, and finally through an overflow outlet to a surrounding leach field. Perforated diffusers in the lower ends of the ozonating tanks are connected to an ozone generator which intermittently supplies ozone gas to the diffusers. Excess ozone gas is piped from the upper ends of the ozonating tanks back to the septic tank to increase the effectiveness of the septic tank.

These and other methods utilize ozone in some manner related to the remediation or operation of a septic tank. However, the foregoing methods and other known methods are generally complicated and critical components are subject to clogging, plugging and other maintenance challenges. Ozonation techniques employed in the purification of potable water are not easily implemented in a septic tank system due to the dramatically greater amount of dissolved and suspended solids giving rise to a high chemical, and biological, oxygen demand, as a result of the frequent introduction of solid materials such as household wastes, together with the infrequent, or unintended, introduction of grass clippings and leaves into these outdoor systems.

### BRIEF SUMMARY

The present invention provides a highly efficient and reliable system for introducing ozone gas into secondary wastewater of a septic system to inactivate harmful microbiological organisms (pathogenic microorganisms), disinfect the secondary wastewater, oxidize organic and inorganic contaminants, and/or eliminate odors. The present ozonation systems for introducing ozone gas into secondary wastewater may be installed with new or existing septic systems. The ozonation systems of the present invention may be beneficially used to improve the operation and efficacy of a septic system and enable the system to meet or exceed regulatory limits placed on the effluent from a septic system.

Various embodiments of the present invention provide a septic system comprising one or more corona discharge ozone gas generators having at least one inlet for receiving a source of air and at least one outlet that allows the withdrawal of a mixture of air and ozone gas. Typically, the source of air is atmospheric air. The septic system also comprises a septic tank for receiving primary wastewater, and a pump tank having an inlet receiving secondary wastewater from the septic tank, a discharge, and an ozone introduction pump disposed in the bottom of the pump tank and submersed in the secondary wastewater, wherein the ozone introduction pump includes an impeller within a housing having an inlet and, further, wherein the housing comprises a plurality of radial outlet ports along its circumferential area surrounding the impeller as an outlet. A conduit is coupled between the outlet of the one or more corona discharge ozone generators and the inlet of the impeller housing, wherein the ozone introduction pump operates to form a reduced pressure in the conduit, which may or may not be a negative pressure, that draws air into the ozone generator and draws the mixture of air and ozone gas into the impeller housing for introduction of the air and ozone gas into the secondary wastewater. The secondary wastewater is drawn into, and expelled from, the housing through the radial outlet ports due to the rotary action of the impeller. Creation of a reduced pressure in the conduit, and the introduction of ozone gas into the secondary wastewater is affected by factors including, but not limited to, the power consumption of the prime mover coupled mechanically to the impeller, the size (diameter) of the impeller, the percentage of the circumferential area of the impeller housing comprising the radial outlet ports, the height (head) of water above the radial outlet ports in the impeller housing, the viscosity of the fluid, and the fluid temperature.

In one embodiment, the foregoing septic system further comprises a pressure differential switch disposed to detect a reduced pressure in the conduit, and a controller in electronic communication with the pressure differential switch for preventing operation of the ozone generator in the absence of a reduced pressure indication from the pressure differential switch.

In another embodiment, the impeller housing of the pump in the foregoing septic system comprises a plurality of radial outlet ports that comprise more than 75 percent of the impeller circumferential area.

In yet another embodiment, the foregoing septic system further comprises an air drier coupled to the at least one inlet of the one or more ozone generators, wherein the ozone introduction pump operates to form a reduced pressure in the conduit which draws air through the air drier and into the one or more ozone generators and draws the mixture of air and ozone gas into the impeller housing for introduction into the secondary wastewater.

In a further embodiment, the foregoing septic system further comprises an ultraviolet light source disposed in the headspace above the secondary wastewater in the pump tank.

### BRIEF DESCRIPTION OF THE SEVERAL VIEWS OF THE DRAWINGS

FIG. 1 is a diagram of the major components in a residential, or small commercial, septic system in which an ozonation system of the present invention may be implemented.

FIG. 2 is a schematic diagram of a portion of the residential, or small commercial, septic system of FIG. 1 including an ozonation system.

FIG. 3 is a side view of a submersible pump having an impeller housing comprising a plurality of radial outlet ports, and, further, wherein the housing is also in fluid communication with one or more ozone generators through a conduit.

FIG. 4 is a cross-sectional view of the impeller housing taken along line 4-4 in FIG. 3 to show the top of the impeller and the radial fluid outlet ports in the housing.

FIG. 5 is a system diagram for producing and delivering ozone gas into the secondary wastewater in the pump tank, including various optional components.

### DETAILED DESCRIPTION

Various embodiments of the present invention provide a septic system incorporating an ozonation system comprising one or more corona discharge ozone generators having an inlet for receiving air from a source of air and an outlet that allows the withdrawal of a mixture of air and ozone gas. The source of air is normally atmospheric air but may be compressed air in a pressure tank. The septic system also comprises a septic tank for receiving primary wastewater, and a pump tank having an inlet receiving secondary wastewater from the septic tank, and a pump tank discharge. The ozonation system includes a submersible ozone introduction pump disposed in the bottom of a contact chamber (preferably the pump tank), wherein the ozone introduction pump includes an impeller within a housing, the housing having an inlet and a plurality of radial outlet ports along its circumferential area surrounding the impeller as an outlet. A conduit is coupled between the outlet of the one or more corona discharge ozone generators and the inlet of the impeller housing, wherein the ozone introduction pump operates to form a reduced pressure in the conduit, which may or may not be a negative pressure, that draws air into the ozone generator and draws the mixture of air and ozone gas into the impeller housing for introduction (i.e., mixing, entrainment and/or diffusion) of the ozone gas into the secondary wastewater drawn into, and expelled from, the housing through the radial outlet ports due to the rotary action of the impeller. Creation of reduced pressure in the conduit, and the introduction of ozone gas in the secondary wastewater is affected by factors including, but not limited to, the power consumption of the prime mover mechanically coupled to the impeller, the size (diameter) of the impeller, the percentage of the circumferential area of the impeller housing comprising the radial outlet ports, the height (head) of water above the radial outlet ports in the impeller housing, the viscosity of the fluid, and the fluid temperature.

Dynamic and displacement pump types are known to one of ordinary skill in the art of pumps. To practice the present invention, dynamic pump types are required in which energy is continuously added to increase fluid velocities within the pump to values greater than those occurring at the discharge. Dynamic pumps may be further subdivided into several varieties of centrifugal and other special-effect pumps. A centrifugal pump is a rotating machine in which fluid flow and pressure are generated dynamically, and a centrifugal pump delivers useful energy to a fluid largely through velocity changes that occur as the fluid flows through an impeller and any associated fixed passageways of the pump; that is, it is a rotodynamic pump. All impeller pumps are rotodynamic, including those with radial-flow, mixed-flow, and axial-flow impellers. Although the actual flow patterns within a centrifugal pump are three-dimensional and unsteady in varying degrees, one of ordinary skill in the art can readily establish the geometry, or fluid dynamical design, of impellers and stators, or stationary passageways, of such pumps. One of ordinary skill in the art of centrifugal pumps also can readily deduce pump operational characteristics, for example, power input and fluid head versus fluid flow rate, at both the optimum or design conditions and off-design conditions. The complexities of the flow in a centrifugal pump need to be considered when the power input for a given size pump becomes relatively large. Fluid phenomena such as recirculation, cavitation, and pressure pulsations become important; “hydraulic” and mechanical interactions—involving stress, vibration, rotor dynamics, as well as the materials used—become critical; and operational limits must be understood and respected.

The septic system may be any of various present or future designs and the septic tank and pump tank may be separate vessels or separate chambers of a unitary vessel. The tanks are typically installed underground, but this is not necessary to the operation of the invention. It should be recognized that the dimensions and capacities of the vessels will vary based upon the wastewater load placed upon the septic system and is determinable by those having ordinary skill in the art. Furthermore, the inlets to the tanks and the outlets from the tanks may be coupled with conduits or formed by openings in a wall between adjacent tanks. The septic system will generally be constructed using the same or similar materials of any existing septic system, however, components and tanks that are expected to come into contact with ozone may be constructed with, or coated with, an ozone resistant material. For example, suitable ozone-resistant materials include: polyvinylchloride; polypropylene; polyethylene; fully, or partially, halogenated polymers, such as, polytetrafluoroethylene (Teflon®), and polyvinylidenedifluoride (PVDF), as well as concrete-based tanks.

The septic system may or may not include one or more pumps for moving effluent between the tanks and into any drain field. However, the present invention separately includes a submersible ozone introduction pump disposed in the bottom of a contact chamber or tank, such as the pump tank, wherein the ozone introduction pump includes an impeller within a housing having an inlet and, further, wherein the housing comprises a plurality of radial outlet ports along its circumferential area surrounding the impeller as an outlet. A first end of a conduit is in fluid communication with the outlet of the one or more corona discharge ozone generators and a second end of the conduit is in fluid communication with the inlet of the impeller housing. When the ozone introduction pump is turned on and fully operational, the rotary action of the pump impeller induces a reduced pressure within the conduit which draws air through the ozone generator, then draws the air and ozone gas produced in the ozone generator through the conduit and into the impeller housing for introduction of the ozone gas into the secondary wastewater. Simultaneously, the rotary action of the ozone introduction pump impeller continuously causes the secondary wastewater to be drawn into, and expelled from, the impeller housing through the plurality of radial outlet ports along the circumferential area of the housing surrounding the impeller. Further, the rotary action of the impeller within the housing, containing the two phase mixture of secondary wastewater (a liquid) and air containing ozone (a gas), causes the gas stream to be divided into very fine bubbles having dimensions in the range 1 to 2,000 microns, preferably from 1 to 200 microns, and more preferably from 1 to 100 microns, greatly facilitating the introduction of ozone gas into the secondary wastewater. In addition, the rotary action of the impeller within the housing of the pump causes circulation of the secondary wastewater containing dissolved ozone within the pump tank, thus, transporting the dissolved ozone throughout the pump tank and into contact with the walls of the pump tank. Dissolved ozone may reduce fecal coliform counts as well as inactivate pathogenic microorganisms in the secondary wastewater, such as E. coli 0157-H7 found in the wastewater effluent discharged from many septic systems. Disinfection of the secondary wastewater may also be achieved. Still further, ozonation may remove various compounds or elements, such as cyanides, phenols, iron, manganese, detergents, endocrine disruptors, and pharmaceuticals.

The conduit that is coupled between the outlet of the one or more corona discharge ozone generators and the inlet of the pump impeller housing may take various forms including, without limitation, pipes, tubing, channels, and combinations thereof. Since the conduit transports ozone, typically in the form of air containing about 2 weight percent ozone, the conduit is suitably made with polyvinylchloride (PVC), TYGON tubing (available from Saint-Gobain Corporation, France), perfluoroalkoxy resins (PFA), fluorinated ethylene propylene (FEP), polytetrafluoroethylene, ethylene teatrafluoroethylene (ETFE), ethylene chlorotrifluoroethylene (ECTFE), NEOPRENE (available from E.I. du Pont de Nemours and Company, Wilmington, Deleware), polyvinylidene fluoride (PVDF), and P-chlorotrifluorethylene (P-CTFE). Similarly, since the pump and related components will also come into contact with ozone gas and ozonated water, the pump impeller, shaft, housing and connecting structures may, for example, be made from any of the foregoing materials or metals such as aluminum, stainless steel (304L or 316L), INCONEL (available from Special Metals Corporation, New Hartford, N.Y.), HASTELLOY-C (available from Haynes International, Inc., Kokomo, Ind.) and titanium.

In one embodiment, the foregoing septic system further comprises a pressure differential switch disposed to detect a reduced pressure in the conduit, and a controller in electronic communication with the pressure differential switch for preventing operation of the ozone generator in the absence of a reduced pressure indication from the pressure differential switch. The pressure differential switch is disposed to atmospheric pressure as well as to the pressure within the conduit and is designed to detect a pressure differential between the pressure within the conduit and atmospheric pressure. The switch may either measure the pressure differential or merely detect the existence of a pressure differential. In either case, the switch provides a signal to a controller indicating that there is a reduced pressure within the conduit. The reduced pressure is an indication that the ozone introduction pump has been turned on, is operational, and is drawing air through the conduit.

Optionally, the controller will not turn on the one or more corona discharge ozone generators unless the pressure differential switch is providing a signal indicating that a reduced pressure is present within the conduit. It is generally insufficient for the controller to merely send an enable signal to the ozone introduction pump and trust that the pump will operate properly. For example, the ozone introduction pump may have mechanically failed, the pump prime mover, such as, an electric motor, may have burned out, the electrical power circuit to the pump motor may have been compromised, or the pump outlet ports may be physically obstructed. In any of these conditions, the ozone generators preferably will not be operated since the lack of ozone delivery to the tank will prevent the produced ozone from being effective in treating the secondary wastewater. The absence of a reduced pressure in the conduit may allow ozone to escape containment and pose a hazardous condition to people in the area, and the lack of air circulation through the ozone generators may lead to overheating and damage.

In a further option, the one or more corona discharge ozone generators includes a plurality of corona discharge ozone generators, each of the plurality of corona discharge ozone generators disposed for parallel air flow there through. Using a plurality of corona discharge ozone generators fluidically in parallel allows each of the generators to be smaller and more easily cooled and provides a degree of built-in redundancy. For example, the plurality of corona discharge ozone generators may produce a given amount of ozone at lower temperature than a single corona discharge ozone generator producing the same amount.

In another embodiment, the impeller housing outlet of the ozone introduction pump comprises a radial distribution of outlet ports that comprise more than 75 percent of the impeller circumferential area. The radial outlet ports in the impeller housing allow the ingress of the secondary wastewater and the egress of secondary wastewater containing dissolved ozone gas. Optionally, the impeller housing has between 3 and 9 unobstructed radial outlet ports. In an independent option, the radial outlet ports are substantially evenly distributed about the circumference of the impeller to provide introduction of ozone and circulation of secondary wastewater in all directions about the pump impeller. In a preferred configuration, the conduit is coupled to the inlet of the impeller housing of the ozone introduction pump in alignment with an axis of rotation of the impeller. In a further preferred configuration, the submersible ozone introduction pump includes a prime mover, such as, an electric motor, disposed below the impeller, and the conduit extends vertically downward into the tank to the inlet of the impeller housing of the pump.

In yet another embodiment, the foregoing septic system further comprises an air drier coupled to the inlet of the one or more ozone generator, wherein the ozone introduction pump operates to form a reduced pressure in the conduit which draws air through the air drier and into the ozone generator and then draws the mixture of air and ozone gas through the conduit into the impeller housing for introduction into the secondary wastewater. The air drier is beneficial for removing water vapor from the air before it enters the one or more corona discharge ozone generators. Water vapor in the corona discharge can lead to the formation of oxides of nitrogen and ultimately nitric acid. An air drier may include, without limitation, a pressure swing absorption unit or a desiccant-containing chamber.

A separate optional feature of the present ozone-containing septic systems is a manually-accessible port in the conduit where the port is not submersed in the secondary wastewater. Such a port enables temporary insertion of an ozone testing device into the conduit for testing the ozone concentration in the mixture of air and ozone gas within the conduit. A suitable ozone test element includes a latex band stretched between two hooks. Such a latex band is secured to a plug that fits into the manually accessible port and the ozone generators are turned on for a predetermined test time. After the test time has elapsed, the plug is removed and the latex band is inspected. If the latex band has failed, then the ozone generators are operating properly and the ozone concentration is determined to be sufficient. However, if the latex band is still intact, then the ozone concentration has declined below an acceptable level and further troubleshooting of the corona discharge units is required.

In a further embodiment, the foregoing ozone-containing septic system further comprises an ultraviolet light source disposed in the headspace of the same tank that contains the ozone introduction pump. A UV-transparent tube, only, surrounds the ultraviolet light source disposed in the headspace of the pump tank. In this case, UV light photons transmitted through the UV-transparent tube interact with ozone gas molecules that may be present in the headspace gas causing them to be decomposed back to oxygen gas molecules. In addition, a gas-phase advanced oxidation process arising from the interaction of UV light photons with ozone gas molecules in the headspace gas may bring about the oxidative decomposition of any odorous or toxic volatile organic compounds and any aerosolized microbiological species in the headspace of the pump tank.

The septic systems of the present invention may be implemented, for example, where the primary wastewater is the discharge from a residential plumbing system. Aside from its source, the primary wastewater may, for example, be selected from greywater, blackwater, or a combination thereof. Ozone may be introduced into the secondary wastewater, for example, to combat odors and/or reduce the chemical and/or biological oxygen demands. In a further option, the ozone generator provides a sufficient amount of ozone dissolved into the secondary wastewater in the tank to inactivate, or reduce the concentration of, any microorganisms within the secondary wastewater, in particular, any pathogenic bacteria, viruses, or spores. Further, secondary wastewater containing dissolved ozone may reduce or prevent the growth of pathogenic, or non-pathogenic, biological matter, such as biofilms, or mats, from growing on the walls of the pump tank, components submerged or suspended in the pump tank, conduit leading from the pump tank to a drain field and the drain field itself, thus, avoiding any clogging, blocking or malfunctioning of any components, or the septic system itself. Dissolved ozone may also disinfect the secondary wastewater.

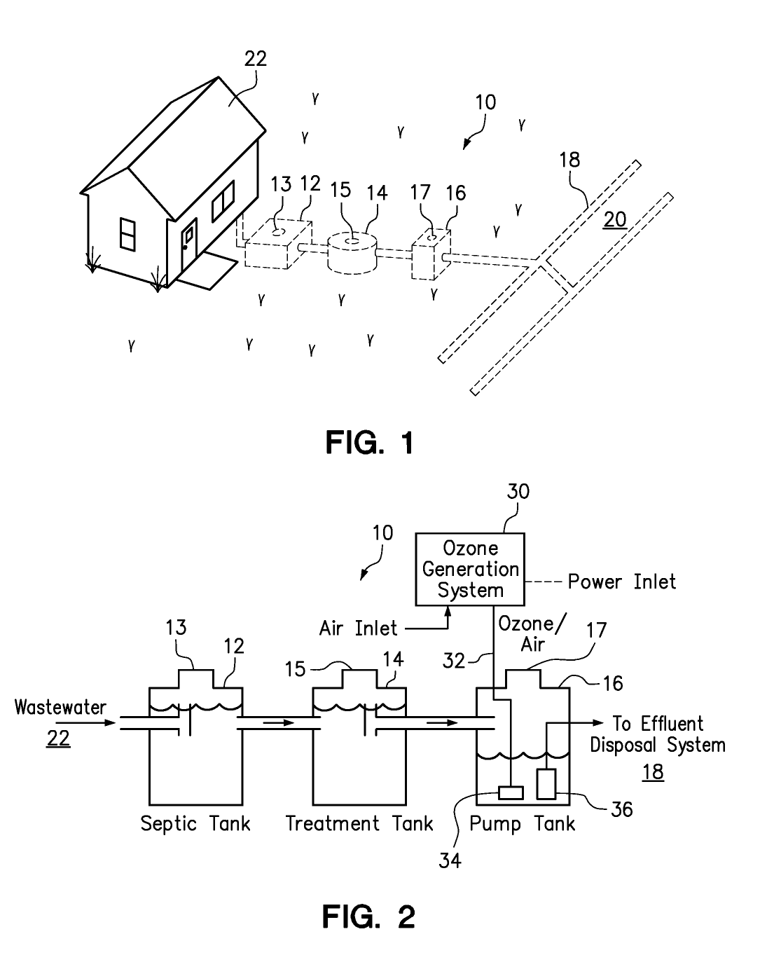

FIG. 1 is a diagram of the major components in a residential, or small commercial, septic system in which an ozonation system of the present invention may be implemented. The septic system 10 includes a septic tank 12, an aerobic treatment tank 14, a pump tank 16 and a wastewater effluent disposal system 18 distributing the treated secondary wastewater effluent to a leach field 20. The septic system 10 is shown installed underground behind a residence 22, wherein the septic tank 12 receives primary wastewater from the residence 22. Wastewater from the septic tank 12 overflows into the aerobic treatment tank 14 and secondary wastewater from the aerobic treatment tank overflows into the pump tank 16. A secondary wastewater effluent pump in the pump tank 16 may be used to deliver secondary wastewater effluent to the disposal system 18. Each of the tanks 12, 14, 16 includes a manway cover 13, 15, 17 to allow access for cleaning and maintenance.

FIG. 2 is a schematic diagram of a portion of the residential, or small commercial, septic system 10 of FIG. 1 including an ozonation system. The ozonation system is shown including a corona discharge ozone generator 30 coupled to a source of electrical power for generating ozone gas. The ozone generator 30 has an outlet coupled to a conduit 32 that extends into fluid communication with an inlet to a submersible pump 34 that is submersed in the pump tank 16. When the ozone introduction pump 34 is in operation, it creates a reduced pressure within the conduit 32. As a result, air is drawn into the ozone generator 30 and a small portion of the oxygen is converted to ozone gas. A mixture of air and ozone gas is then drawn through the conduit 32 to the ozone introduction pump 34. The ozone introduction pump 34 then introduces (i.e., mixes, entrains and/or diffuses) the air and ozone gas into the secondary wastewater and causes circulation of the ozonated secondary wastewater throughout the volume of liquid present in the pump tank 16. A separate effluent pump 36 is optionally used to lift the secondary wastewater effluent from the pump tank 16 and deliver it into the effluent disposal system 18. A float or other level detection member (not shown) is typically used to turn on the effluent pump 36 as needed. Alternatively, discharge of the secondary wastewater effluent from the pump thank 16 to the effluent disposal system 18 can be made to occur due to gravity flow, thus avoiding the need for effluent pump 36.

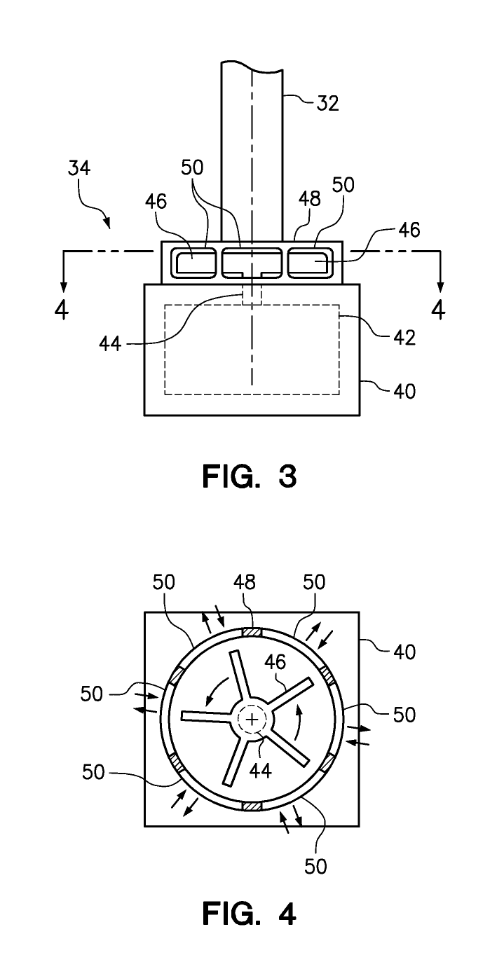

FIG. 3 is a side view of the submersible ozone introduction pump 34 having a electric motor housing 40 enclosing an electric motor 42 that turns a shaft 44 coupled to an impeller 46. The impeller 46 is disposed in an impeller housing 48 having a plurality of radial outlet ports 50 that are substantially radially open. Accordingly, secondary wastewater from within the pump tank is able to flow into the impeller housing 48 through the radial outlet ports 50 and a mixture of air and ozone gas, along with portions of the secondary wastewater entering the housing, are able to flow out of the impeller housing 48 through the radial outlet ports 50. The impeller 46 and impeller housing 48 are designed so that turning the impeller causes a drop in pressure within the conduit 32 and fluids are pushed out of the impeller housing 48. As the ozone introduction pump 34 continues to operate, the net effect is that air and ozone gas diffuse into the fluid surrounding the pump. The rotary action of the impeller 46 within the housing 48 causes the mixture of air and ozone gas to form very fine bubbles of gas having dimensions in the range, 1 to 2,000 microns, preferably 1 to 500 microns, and more preferably from 1 to 100 microns, resulting in a high surface area to volume of the gas bubbles in the two phase flow circulating within the housing 48 giving rise to effective introduction of ozone gas into the secondary wastewater, thus, maximizing both the dissolution of ozone into the secondary wastewater and the inactivation of pathogenic microorganisms.

FIG. 4 is a cross-sectional view of the impeller housing 48 taken along line 4-4 in FIG. 3 to show the top of the impeller 46 and the radial outlet ports 50 in the housing 48. The electric motor within the motor housing 40 turns the shaft 44 causing the impeller to rotate (here shown as counterclockwise rotation). Adjacent each radial outlet port 50 is a radially inwardly-directed arrow and a radially outwardly-directed arrow to symbolize the general balance of the secondary wastewater entering the impeller housing 48 and secondary wastewater exiting the impeller housing 48 with very fine bubbles of air and ozone gas, mixed and entrained with the secondary wastewater giving rise to rapid diffusion and dissolution of ozone gas into the secondary wastewater. It should be recognized that the fluid flow is not truly radial, but turbulent. Still, it has been found that there is generally a flow of water in and out of the housing and that, in this manner, circulation may be induced throughout the liquid volume in the pump tank.

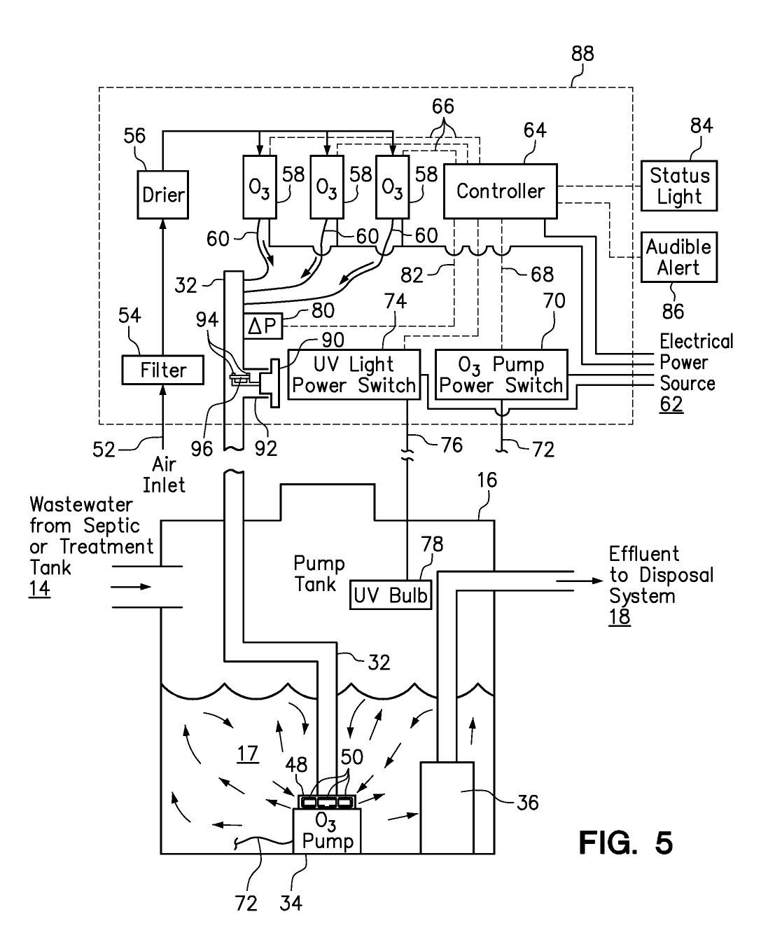

FIG. 5 is a block diagram of a system for producing and delivering ozone gas into the secondary wastewater 17 in the pump tank 16, including various optional components. As discussed in relation to FIG. 1, secondary wastewater from the septic tank 12 or aerobic treatment tank 14 overflows into the pump tank 16 and secondary wastewater exceeding a certain level in the pump tank 16 may be pumped out to an effluent disposal system 18 using the effluent pump 36. The submersible ozone introduction pump 34 is disposed in the bottom of the pump tank 16, and is preferably secured in position. When the ozone introduction pump 34 is operating, an impeller within the housing 48 rotates rapidly forcing the secondary wastewater and gases within the conduit 32 outward into the tank 16. The pump introduces the gases into the secondary wastewater within the tank and establishes circulation in the tank. Accordingly, ozone gas dissolved in the secondary wastewater, and any ozone gas present in the headspace above the secondary wastewater in the pump tank 16, is effective in inactivating pathogenic, as well as non-pathogenic, microorganisms in the pump tank 16.

The operating pump 34 draws air through an inlet 52, a particulate filter 54, and a drier 56 to remove water vapor from the air before it enters the corona discharge units 58. The three corona discharge units 58 receive parallel streams of air and each produce about 2 weight percent ozone gas in air at their outlets 60. Tubing provides a passage for the ozone gas and air from the outlets 60 to the conduit 32 that, alone or in combination with other conduits or tubing, extends into the pump tank 16 for communication with the impeller housing 48 and introduction into the secondary wastewater 17 within the pump tank 16.

Each of the corona discharge ozone generators 58 receives power from an electrical power source 62 and is controlled by a controller 64 via a signal line 66. Although the ozone generators 58 are shown as being independently controlled, they may also be controlled as a group. The controller 64 also controls the operation of the pump 34 via a signal line 68 to a power switch 70 that controls power from the electrical power source 62 over the electrical wire 72 to the pump 34. Similarly, the controller 64 controls a UV light power switch 74 that controls power from the source 62 over the electrical wire 76 to a UV light bulb 78 disposed within the pump tank 16. Accordingly, the controller 64 can control the operation of the ozone generators 58, the pump 34, and the UV bulb 78.

The system further includes a differential pressure sensor 80 disposed to compare the gas pressure inside the conduit 32 with the ambient air pressure outside the conduit 32. The differential pressure sensor 80 provides a signal over the signal line 82 to the controller 64 indicating that the pressure in the conduit 32 is less than ambient pressure, preferably by some known precalibrated amount. In this manner, a signal from the differential pressure sensor 80 indicates to the controller 64 that the ozone introduction pump 34 is operational, meaning that it is receiving electrical power, the impeller is not mechanically stuck, the radial outlet ports 50 are not clogged or plugged, the air filter 54 is not clogged or plugged, and the conduit 32 is properly coupled to the pump 34. In a preferred embodiment, the controller 64 includes analog circuitry or an application specific integrated circuit (ASIC) to enable the ozone generators 58 only while the ozone introduction pump 34 is operational (i.e., only while receiving a signal from the differential pressure sensor 80).

User alerts or status indicators may take various forms, but preferably include at least a status light 84 and an audible alert or tone generator 86. For example, the status light 84 may be mounted on the exterior of a weather-resistant housing 88 that protects many of the electronic components shown in FIG. 5 from water, dust, dirt, insects, and small wild animals. Accordingly, the status light 84 may indicate to a user or owner that the controller has determined the system is operating properly or improperly. The audible alert 86 is preferably only activated to indicate improper functioning, a need for maintenance, or a loss of power.

Finally, FIG. 5 shows a plug 90 inserted into a port 92 in the conduit 32. The plug 90 supports a wire forming a pair of hooks 94 that are able to receive a latex band 96 and dispose the latex band into the conduit 32. If the ozone generators 58 are producing sufficient concentrations of ozone gas, then the latex band 96 will degrade and fail in a predeterminable time period. Accordingly, the ozone generators 58 may be periodically tested through the manual operation of removing the plug, attaching a fresh latex band, reinstalling the plug for a predetermined time period while the ozone generators are energized, then removing the plug. If the latex band is intact following the predetermined time period, then the ozone generators 58 require maintenance or replacement.

### EXAMPLES

### Example 1

An experimental setup was assembled comprising an ozone generator 30, conduit 32 and ozone introduction pump 34, consistent with the system of FIG. 2. This setup was used for the introduction of a mixture of air and ozone gas into the secondary wastewater contained in a pump tank 16 of a first residential septic system 10, which was nominally rated to treat 500 gallons per day (GPD) of wastewater. The ozone generator comprised three identical corona discharge type ozone generators (model number 250MGH120VPB, Ozone Engineering, El Sobrante, Calif.). The outlets of the three ozone generators were connected fluidically in parallel to the conduit. The conduit was made from 1.27 cm diameter polyvinylchloride (PVC) tubing. The conduit extended into fluid communication with the inlet of a submersible centrifugal pump (model number 950, Danner Manufacturing, Inc., Islandia, N.Y.), which had a rated power requirement of 60 Watts (115 VAC). The impeller housing of the centrifugal pump had a plurality of radial ports, consistent with the ports 50 in the housing 48 of pump 34 shown in FIG. 3. The head, or height, of wastewater over the impeller housing 48 of the submersible pump 34 in pump tank 16 varied on a daily basis depending upon the rate of overflow of secondary wastewater from the aerobic treatment tank 14 and the rate of discharge of ozone-treated secondary wastewater from the pump tank 16 to the effluent disposal system 18. The height of the secondary wastewater over the impeller housing 48 varies between a minimum of about 15 cm and a maximum of about 53 cm. The corresponding flow rates of the mixture of air and ozone through the conduit 32 were 12 L/min and 4 L/min.

Prior to installation of the experimental setup for ozone introduction, two 100 mL samples of the secondary wastewater in the pump tank 16 were taken eight days apart and the fecal coliform counts (CFU/100 mL) were determined by a commercial microbiology test laboratory (Aqua-tech Laboratories, Inc., Bryan, Tex.). The high fecal coliform counts obtained are listed in Table 1 below. After installing the experimental setup, including the ozone generator 30, conduit 32 and ozone introduction pump 34, the electric motor 42 was turned on that rotated a shaft 44 coupled to an impeller 46 disposed in the impeller housing 48, which cause a flow of air through the ozone generators and into the water within the pump tank. Shortly afterward a source of electrical power was turned on to the ozone generators 30, which brought about the production of ozone gas in the flowing air stream. As a result, a mixture of air and ozone was introduced into the secondary wastewater in the pump tank 16.

On average, the rate of ozone production was about 750 mg per hour. Periodically, over a period of about one year, a number of 100 mL samples of the ozone-treated secondary wastewater was withdrawn from pump tank 16, and analyzed for fecal coliform. The significantly lower values of fecal coliform counts derived from the ozone-treated secondary wastewater are also listed in Table 1 below. The fecal coliform counts measured for the ozone-treated secondary wastewater on various days were, in almost all cases, less than the Environmental Protection Agency (EPA)-regulated value of 200 CFU/100 mL.

TABLE 1

| Wastewater | | Fecal |
|---|---|---|
| Sample | | Coliform |
| Collection | Ozonation | Count MPN, |
| Day | Status | CFU/100 mL |
| Sample #1 | No | 7.1 × 10⁶ |
| Prior to | | |
| Ozone | | |
| Introduction | | |
| Sample #2 | No | 3.4 × 10⁷ |
| Prior to | | |
| Ozone | | |
| Introduction | | |
| Day 1 | Yes | 27 |
| Day 14 | Yes | 45 |
| Day 21 | Yes | 9 |
| Day 29 | Yes | 460 |
| Day 31 | Yes | 73 |
| Day 35 | Yes | 220 |
| Day 38 | Yes | 440 |
| Day 49 | Yes | 1310 |
| Day 50 | Yes | 88 |
| Day 52 | Yes | 119 |
| Day 57 | Yes | 94 |
| Day 65 | Yes | 35 |
| Day 73 | Yes | 144 |
| Day 199 | Yes | 46 |
| Day 247 | Yes | 70 |
| Day 254 | Yes | 188 |
| Day 261 | Yes | 114 |
| Day 308 | Yes | 27 |
| Day 336 | Yes | 87 |
| Day 337 | Yes | 177 |
| Day 338 | Yes | 108 |
| Day 339 | Yes | 73 |
| Day 344 | Yes | 11000 |
| Day 346 | Yes | 2100 |
| Day 350 | Yes | 73 |
| Day 351 | Yes | 86 |

### Example 2

An experimental setup, which was identical to that of Example 1 and consistent with FIG. 2, was used for the introduction of a mixture of air and ozone gas into secondary wastewater. The air/ozone mixture was introduced to secondary waterwater contained in a pump tank 16 of a second residential septic system 10 that was rated to treat 500 gallons per day (GPD) of wastewater. The fecal coliform counts (CFU/100 mL) of the secondary wastewater in pump tank 16, in the absence and presence of the introduction of ozone into the wastewater are listed in Table 2. Again, the fecal coliform counts measured for the ozone-treated secondary wastewater on various days were, in almost all cases, less than the Environmental Protection Agency (EPA)-regulated value of 200 CFU/100 mL.

TABLE 2

| Wastewater | | Fecal |
|---|---|---|
| Sample | | Coliform |
| Collection | Ozonation | Count MPN, |
| Day | Status | CFU/100 mL |
| Sample | No | 1.6 × 10⁵ |
| Prior to | | |
| Ozone | | |
| Introduction | | |
| Day 1 | Yes | 72 |
| Day 14 | Yes | 54 |
| Day 21 | Yes | 100 |
| Day 29 | Yes | 55 |
| Day 31 | Yes | 9 |
| Day 35 | Yes | 26 |
| Day 38 | Yes | 19 |
| Day 49 | Yes | 1490 |
| Day 50 | Yes | 52 |
| Day 52 | Yes | 3 |
| Day 57 | Yes | 18 |
| Day 65 | Yes | 71 |
| Day 73 | Yes | 81 |
| Day 199 | Yes | 157 |
| Day 247 | Yes | <2 |
| Day 254 | Yes | 15 |
| Day 261 | Yes | 43 |
| Day 308 | Yes | 9 |
| Day 336 | Yes | 320 |
| Day 337 | Yes | 100 |
| Day 338 | Yes | 36 |
| Day 339 | Yes | 91 |
| Day 344 | Yes | 2200 |
| Day 346 | Yes | 173 |
| Day 350 | Yes | 36 |
| Day 351 | Yes | 36 |

### Example 3

A third residential septic system was used as the experimental setup for Example 3. The septic system was identical to that used in Examples 1 and 2 and consistent with the diagram of FIG. 2. Accordingly, a mixture of air and ozone gas was introduced into secondary wastewater contained in the pump tank 16 of the third residential septic system 10, which was rated to treat 500 gallons per day (GPD) of wastewater. The fecal coliform counts (CFU/100 mL) of the secondary wastewater in the pump tank 16, in the absence and presence of the introduction of ozone into the wastewater, are listed in Table 3. Again, the fecal coliform counts measured for the ozone-treated secondary wastewater on various days were, in almost all cases, less than the Environmental Protection Agency (EPA)-regulated value of 200 CFU/100 mL.

TABLE 3

| Wastewater | | Fecal |
|---|---|---|
| Sample | | Coliform |
| Collection | Ozonation | Count MPN, |
| Day | Status | CFU/100 mL |
| Sample | No | 3.2 × 10⁶ |
| Prior to | | |
| Ozone | | |
| Introduction | | |
| Day 1 | Yes | 480 |
| Day 12 | Yes | 73 |
| Day 13 | Yes | 55 |
| Day 14 | Yes | 42 |
| Day 15 | Yes | 148 |
| Day 20 | Yes | 9 |
| Day 28 | Yes | 1 |
| Day 36 | Yes | 2 |
| Day 43 | Yes | 450 |
| Day 50 | Yes | 102 |
| Day 162 | Yes | <2 |
| Day 210 | Yes | <2 |
| Day 217 | Yes | 62 |
| Day 224 | Yes | 4 |
| Day 271 | Yes | <1 |
| Day 299 | Yes | <1 |
| Day 300 | Yes | <1 |
| Day 301 | Yes | <1 |
| Day 302 | Yes | 4 |
| Day 307 | Yes | <9 |
| Day 309 | Yes | <9 |
| Day 313 | Yes | <9 |
| Day 314 | Yes | <9 |

### Example 4

A fourth residential septic system, rated to treat 500 gallons per day (GPD) of wastewater, was used as the experimental setup for Example 4 in a manner identical to that of Examples 1-3 and consistent with the diagram of FIG. 2. Accordingly, a mixture of air and ozone gas was introduced into the secondary wastewater contained in the pump tank 16 of the fourth residential septic system. The fecal coliform counts (CFU/100 mL) of the secondary wastewater in pump tank 16, in the absence and presence of the introduction of ozone into the wastewater, are listed in Table 4. Again, the fecal coliform counts measured for the ozone-treated secondary wastewater on various days were, in almost all cases, less than the Environmental Protection Agency (EPA)-regulated value of 200 CFU/100 mL.

TABLE 4

| Wastewater | | Fecal |
|---|---|---|
| Sample | | Coliform |
| Collection | Ozonation | Count MPN, |
| Day | Status | CFU/100 mL |
| Sample | No | 2.1 × 10⁵ |
| Prior to | | |
| Ozone | | |
| Introduction | | |
| Day 1 | Yes | 6 |
| Day 2 | Yes | 4200 |
| Day 3 | Yes | 5800 |
| Day 4 | Yes | 6100 |
| Day 9 | Yes | 88 |
| Day 29 | Yes | 15 |
| Day 50 | Yes | 10 |
| Day 78 | Yes | <1 |
| Day 79 | Yes | 8 |
| Day 80 | Yes | 32 |
| Day 81 | Yes | 8 |
| Day 86 | Yes | <9 |
| Day 88 | Yes | 18 |
| Day 92 | Yes | <9 |
| Day 93 | Yes | <9 |

As will be appreciated by one skilled in the art, certain aspects of the present invention may be embodied as a system, method or computer program product. Accordingly, the controller may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible storage medium having computer-usable program code stored on the storage medium.

Any combination of one or more computer usable or computer readable storage medium(s) may be utilized. The computer-usable or computer-readable storage medium may be, for example but not limited to, an electronic, magnetic, electromagnetic, or semiconductor apparatus or device. More specific examples (a non-exhaustive list) of the computer-readable medium include: a portable computer diskette, a hard disk, random access memory (RAM), read-only memory (ROM), an erasable programmable read-only memory (EPROM or Flash memory), a portable compact disc read-only memory (CD-ROM), an optical storage device, or a magnetic storage device. The computer-usable or computer-readable storage medium could even be paper or another suitable medium upon which the program is printed, as the program can be electronically captured via, for instance, optical scanning of the paper or other medium, then compiled, interpreted, or otherwise processed in a suitable manner, if necessary, and then stored in a computer memory. In the context of this document, a computer-usable or computer-readable storage medium may be any storage medium that can contain or store the program for use by a computer. Computer usable program code contained on the computer-usable storage medium may be communicated by a propagated data signal, either in baseband or as part of a carrier wave. The computer usable program code may be transmitted from one storage medium to another storage medium using any appropriate transmission medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention has been described with reference to illustrations and/or block diagrams of various apparatus (systems). It should be understood that the methods described in relation to the apparatus and the methods performed by the apparatus in the figures may be implemented or controlled by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified.

These computer program instructions may also be stored in a computer-readable storage medium that can direct a computer or other programmable data processing apparatus to function in a particular manner, such that the instructions stored in the computer-readable storage medium produce an article of manufacture including instruction means which implement the function/act specified.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified.

The flowchart and block diagrams in the Figures illustrate the architecture, functionality, and operation of possible implementations of systems, methods and computer program products according to various embodiments of the present invention. In this regard, each step of the methods described may represent a module, segment, or portion of code, which comprises one or more executable instructions for implementing the specified logical function(s). In some alternative implementations, the steps may occur out of the order noted in relation to the figures. For example, two steps described in succession may, in fact, be executed substantially concurrently, or the steps may sometimes be executed in the reverse order, depending upon the functionality involved.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A wastewater treatment system comprising:
one or more corona discharge ozone generators having an inlet for receiving air and an outlet that allows the withdrawal of a mixture of air and ozone gas;
a septic tank for receiving primary wastewater;
a pump tank having an inlet receiving secondary wastewater effluent from the septic tank, a discharge, and a submersible ozone introduction pump disposed in the bottom of the pump tank, wherein the ozone introduction pump includes an impeller within a housing, wherein the housing has an inlet and a plurality of radial outlet ports; and
a conduit coupled between the outlet of the one or more corona discharge ozone generators and the inlet of the housing, wherein the ozone introduction pump operates to reduce the pressure in the conduit which draws air into the ozone generator and draws the mixture of air and ozone gas into the housing for introduction into the secondary wastewater.

2. The system of claim 1, wherein the ozone introduction pump includes a centrifugal impeller, and wherein the plurality of radial outlet ports comprise more than 75 percent of the impeller circumferential area.

3. The system of claim 2, wherein the plurality of radial outlet ports includes from 3 to 9 radial outlet ports.

4. The system of claim 2, wherein the plurality of radial outlet ports allow the entry of secondary wastewater to the housing and the exit of secondary wastewater having ozone dissolved in, entrained in, and/or mixed with, the secondary wastewater from the housing.

5. The system of claim 2, wherein the conduit is coupled to the inlet of the ozone introduction pump in alignment with an axis of rotation of the impeller.

6. The system of claim 2, wherein the plurality of radial outlet ports allow the ingress of secondary wastewater and the egress of ozone-entrained secondary wastewater.

7. The system of claim 6, wherein the plurality of radial outlet ports are substantially evenly distributed about the circumference of the impeller.

8. The system of claim 7, wherein the submersible ozone introduction pump includes a prime mover disposed below the impeller, and wherein the conduit extends vertically downward to the inlet of the housing.

9. The system of claim 1, further comprising:
a pressure differential switch disposed in the conduit to detect reduced pressure, in the conduit; and
a controller in electronic communication with the pressure differential switch for preventing operation of the one or more ozone generators in the absence of reduced pressure indication from the pressure differential switch.

10. The system of claim 1, wherein the one or more corona discharge ozone generators include a plurality of corona discharge ozone generators, each of the plurality of corona discharge ozone generators disposed for parallel air flow therethrough.

11. The system of claim 10, characterized in that the plurality of corona discharge ozone generators produce a given amount of ozone at lower temperature than a single corona discharge ozone generator producing the same amount.

12. The system of claim 1, further comprising:
an ultraviolet light source disposed in the headspace of the pump tank above the secondary wastewater.

13. The system of claim 1, wherein the septic tank is an anaerobic tank.

14. The system of claim 13, further comprising:
an aerobic tank fluidically disposed between the septic tank and the pump tank.

15. The system of claim 14, wherein the primary wastewater is the effluent from a residential plumbing system.

16. The system of claim 14, wherein the primary wastewater includes wastewater selected from greywater, blackwater, or a combination thereof.

17. The system of claim 16, wherein the ozone generator provides a sufficient amount of ozone gas introduced into the secondary wastewater in the pump tank to lower the fecal coliform count below 200 colony forming units (cfu) per 100 milliliters of the secondary wastewater effluent discharge from the pump tank.

18. The system of claim 16, wherein the ozone generator provides a sufficient amount of ozone gas introduced into the secondary wastewater in the pump tank to lower the E. coli count below 200 colony forming units (cfu) per 100 milliliters of the secondary wastewater effluent discharge from the pump tank.

19. The system of claim 16, wherein the ozone generator provides a sufficient amount of ozone gas introduced into the secondary wastewater in the pump tank to disinfect the secondary wastewater.

20. The system of claim 1, further comprising:
an air drier coupled to the inlet of the one or more ozone generator, wherein the ozone introduction pump operates to form a reduced pressure in the conduit which draws air through the air drier and into the ozone generator.

21. The system of claim 20, wherein the air drier includes a pressure swing absorption system.

22. The system of claim 20, wherein the air drier includes a chamber containing a desiccant.

23. The system of claim 1, wherein the conduit includes a manually-accessible port that is not submersed in the secondary wastewater, wherein the manually-accessible port enables temporary insertion of an ozone testing device into the conduit for testing the ozone concentration in the mixture of air and ozone gas within the conduit.

24. The system of claim 1, wherein the discharge is an effluent disposal system.
